(19) United States
(12) Patent Application Publication
(10) Pub. No.: US 2026/0353108 A1
(43) Pub. Date: Nov. 5, 2026

(54) CHANNEL STRUCTURE FOR IMPROVED AUDIO QUALITY AND MULTI-TALK GROUP VOICE CALL

(71) Applicant: MOTOROLA SOLUTIONS, INC., CHICAGO, IL (US)

(72) Inventors: DAVID G. WIATROWSKI, WOODSTOCK, IL (US); JAMES E. STREED, BARRINGTON, IL (US)

(21) Appl. No.: 19/557,846

(22) Filed: Mar. 5, 2026

Related U.S. Application Data
(60) Provisional application No. 63/768,755, filed on Mar. 7, 2025.

(51) Int. Cl. H04W 24/02; H04W 88/04

(52) U.S. Cl. CPC H04W 24/02; H04W 88/04

(57) ABSTRACT

A TDMA communication system provides for a plurality of subscriber units and a base repeater associated with a trunked controller, the trunked controller receiving channel requests and transmitting channel grants to at least two of the subscribers. The base repeater comprises a microprocessor configured to determine an asymmetric channel structure for voice communications between the plurality of subscriber units and the base repeater, and between the base repeater and the plurality of subscriber units.

### BACKGROUND

Portable communication devices, such as land mobile radio (LMR) subscriber units having push-to-talk (PTT) capability, facilitate communication between users in many environments. LMR portable radios are particularly important to users working in industrial environments, under noisy and/or harsh conditions, where critical communications take place amongst several subscriber units. These subscriber units are often assigned to different “talkgroups.” Critical communications may require communications with radio users participating in multiple talkgroups.

Audio quality is particularly important to radio communications taking place under noisy and/or harsh conditions. Communications taking place in a noisy industrial environment, for example, may encounter challenges associated with PTT radio operations which occur at a very rapid pace with many back-and-forth PTT presses and releases containing short voice segments. Anytime that a subscriber unit user cannot understand a transmission and asks for a repeat, causes operations to slow down.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed subject matter, and explain various principles and advantages of those examples.

FIG. 1 is a communication system according to some aspects of the invention.

FIG. 2 is a block diagram of a subscriber unit included in the communication system of FIG. 1 according to some aspects of the invention.

FIG. 3 is a diagram of a base repeater and trunked controller included in the communication system of FIG. 1 according to some aspects of the invention.

FIG. 4A represents an ETSI-DMR Generic Burst Structure in accordance with some aspects of the invention.

FIG. 4B represents a symmetrical 6:6 TDMA channel structure with a total of 12 bursts with 6 bursts allocated to TDMA channel 1 and 6 bursts allocated to TDMA channel 2 in accordance with some aspects of the invention.

FIG. 4C represents an asymmetrical 8:4 TDMA channel structure with a total of 12 bursts with 8 bursts allocated to TDMA channel 1 and 4 bursts allocated to TDMA channel 2 in accordance with some aspects of the invention.

FIG. 5 is a Table that compares how bits are allocated in the ETSI-DMR symmetrical TDMA channel structure with how they are allocated in the Asymmetrical TDMA channel structure in accordance with some aspects of the invention.

FIG. 6 represents a general Full Link Control PDU in accordance with some aspects of the invention.

FIG. 7 represents a general Shortened Full Link Control PDU in accordance with some aspects of the invention.

FIG. 8 is a Table outlining TACT bits being repurposed to more precisely identify the sequence of bursts on the channel in accordance with some aspects of the invention.

FIG. 9 represents a Multi-Talk Group Voice Channel User full link control PDU (72 bits) in accordance with some aspects of the invention.

FIG. 10 represents a Multi-Talk Group Voice Channel User shortened full link control PDU (50 bits) in accordance with some aspects of the invention.

FIG. 11 represents an example of a series of denied PTT presses throughout an ETSI-DMR voice superframe (360 msec duration).

FIG. 12A represents different types of usable logical channels based on the aligned and offset channel timing combinations of FIG. 12B in accordance with some aspects of the invention.

FIG. 12B is a Table outlining logical channel relationship to inbound and outbound TDMA channels in accordance with some aspects of the invention.

FIG. 13 is diagram of a communication system operating in accordance with some aspects of the invention.

FIG. 14 represents a Multi-Talk Group Voice Service Request and a Multi-Talk Group Voice Grant in accordance with some aspects of the invention.

FIGS. 15, 16, 17, 18, 19, and 20 illustrate a life cycle example of a multi-talk group voice call in accordance with some aspects of the invention.

FIG. 21 is a system level flow chart for multi-talk group voice call in accordance with some aspects of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, features, and aspects illustrated.

The apparatus and method components have been represented where appropriate by conventional symbols in the drawings, showing only those specific details that are pertinent to understanding the examples, features, and aspects so as not to obscure the disclosure with details that will be readily apparent to those of ordinary skill in the art having the benefit of the description herein.

### DETAILED DESCRIPTION

Push-to-talk is a communication technique where a user presses a dedicated button (physical or virtual) on a device to speak with another person. Push-to-talk mode allows only one person to transmit at a time until the button is released. Push-to-talk enables quick and immediate communication with others. Activating a push-to-talk button switches a device between a voice reception mode to a voice transmission mode and is commonly used in land mobile radio (LMR) communications.

The subscriber unit's PTT radio operations may occur at a very rapid pace with many back-and-forth PTT presses & releases containing short voice segments. For example, subscriber users may a) sometimes attempt to respond with their own PTT press after the original talker had stopped talking but before the original talker had released their PTT (see illustration), and b) sometimes attempt to respond with their own PTT press after the original talker has released their PTT but before the radio has padded out the ETSI-DMR voice superframe (360 msec duration) to completion and appended a voice terminator to end its transmission (see illustration). Hence, for the situations noted above, there is a need for responding users to transmit and be heard by all members of a talkgroup despite the PTT status of the original talker's subscriber unit, which will be provided herein as a multi-talk group call.

However, many existing subscriber units are locked into traditional land mobile radio (LMR) architectures. Traditional LMR communication is limited to narrowband audio, and current LMR radio channel data rates and vocoders cannot provide wideband audio due to the channel data rates available. Communication standards, such as those set by the (ETSI-)DMR Association, have not updated their vocoder endorsements (which is DVSI's AMBE+2 for DMR Association) for over 20 years. Consequently, LMR communication systems have been unable to update their vocoder technology in over 20 years.

For example, traditional LMR communication voice data rates may be within the range of 2.25 to 4.4 kbps before Forward Error Correction (FEC) is applied. The channel data rate allocations for audio and FEC is defined and preset. Accordingly, even in areas with relatively strong radio coverage conditions where lower amounts of FEC is necessary, data rate allocations are traditionally constant.

Audio fidelity on narrowband LMR channels needs to be improved, which implies the need for improved vocoder technology and/or more channel data rate throughput to be allocated to voice. Hence, there is a need for a multi-talk group call to allow the responding users to transmit and be heard by all members of the talkgroup in these situations. There is also a need for improved vocoder fidelity and multi-talk group voice call to be balanced.

Accordingly, there is a need for both improved vocoder fidelity and multi-talk group voice call.

There is provided herein, among other things, systems and methods for a channel structure for improved audio quality for multi-talk group voice call.

Examples presented herein offer, among other things, advantages over prior systems and techniques associated with TDMA system group communication.

One example provides a TDMA communication system TDMA communication system, comprising: a plurality of subscriber units, a base repeater associated with a trunked controller, the trunked controller receiving channel requests and transmitting channel grants to at least two of the subscriber units, and wherein the base repeater comprises a microprocessor configured to determine an asymmetric channel structure for voice communications between the plurality of subscriber units and the base repeater, and between the base repeater and the plurality of subscriber units.

The TDMA communication system further comprises a first vocoder and a second vocoder, wherein the first vocoder has a first fidelity level, and the second vocoder has a second, lower, fidelity level. The asymmetric channel structure may comprise a primary channel assigned to a primary subscriber unit for a talker having a higher priority and a secondary channel assigned to a secondary subscriber unit having lower priority operating over uplinks for each of the first and second channels. The asymmetric channel structure may comprise a first channel containing a plurality of burst structures and a second channel containing fewer burst structures than the first channel structure. For example, the asymmetric channel structure may comprise a first channel containing two burst structures; and a second channel containing one burst structure, thereby providing a 2:1 channel structure for the voice communications. Other ratios, for example 3:1, or 4:1 asymmetric channel structures, to name a few, are also possible.

In some aspects the asymmetric channel structure comprises a asymmetrical 8:4 TDMA channel structure with a total of twelve bursts spanning 360 msec, the asymmetrical 8:4 TDMA channel structure allocating eight bursts to one TDMA Channel and four bursts to the other TDMA Channel.

In some aspects, a base repeater manages a talkgroup call between a plurality of subscriber units, wherein: a priority subscriber unit of the talkgroup transmits a voice communication on a first uplink TDMA Channel and the repeater receives the voice communication on the first uplink TDMA Channel, the voice transmission being transmitted (repeated) by the base repeater on a first downlink TDMA Channel and received by subscribers of the talk group on the first downlink TDMA Channel; and a secondary subscriber unit of the talkgroup transmits a secondary voice call on a second uplink TDMA Channel to the base repeater, the base repeater receives the secondary voice call on the second uplink TDMA Channel, the base repeater then transmits (repeats) the second voice call on a second downlink TDMA Channel, and the subscriber units of the talkgroup receive the primary and secondary voice calls on the first and second downlink TDMA Channels.

In some aspects a priority subscriber, of the plurality of subscriber units, receives voice communication from the secondary subscriber unit on the second downlink TDMA Channel and plays the received voice communication at a speaker of the first subscriber unit, the secondary subscriber unit receives voice communication from the primary subscriber unit on the first downlink TDMA Channel and plays the received voice communication at a speaker of the secondary subscriber unit, and the remaining subscriber units receive voice communication from the primary and secondary subscriber units on the first and second downlink TDMA Channels and plays the sum of the received voice communications at a speaker of each of the remaining subscriber units.

The system supports a multi-talk group (a group where there are multiple users transmitting at a time). The primary subscriber transmission may be communicating using nominal fidelity audio of a first vocoder, while the secondary subscriber transmission may be communicating using reduced fidelity audio with respect to the first fidelity audio, of a second vocoder, wherein the TDMA channel structure supports two contemporaneous voice streams, thereby supporting multi-talk group voice call.

Another example provides for a communication system, comprising: a system resource allocator assigning one logical channel, of N logical channels of a repeater, the repeater comprising an uplink TDMA channel on which a subscriber transmits, in response to a PTT press, and a downlink TDMA channel on which the transmission is repeated by the repeater, the subscriber unit being part of a talkgroup; the system resource allocator assigns another one logical channel of the N logical channels of the repeater to all non-transmitting subscriber units belonging to the talkgroup to share, the one logical channel assigned to all non-transmitting subscriber units remains idle and in call hangtime until one of the non-transmitting subscriber units initiates a PTT transmission, using an uplink TDMA channel assigned to the non-transmitting subscriber units, and all subscriber units belonging to the talkgroup receive all active downlink TDMA channels not containing their own repeated transmission, de-vocode the audio streams, sum/mix the audio streams, and render the summed/mixed audio stream to audio speakers of respective subscriber units.

The communication system of claim 14 supports a plurality of subscriber units each transmitting on respective uplink TDMA channels within the talkgroups and the summed/mixed audio stream of the plurality of subscriber units is rendered to audio speakers of each of the plurality of subscriber units. The communication system may further attenuate some audio streams with respect to other audio streams for ease of human understanding, prior to summing/mixing the audio stream. The N assigned logical channels is greater than or equal to 2. The subscriber unit may comprise first and second vocoders, the first vocoder having higher fidelity audio than the second vocoder when using the asymmetric channel strcture.. Therepeater also supports a symmetric channel structure in which the subscriber's first and second vocoders are of equal fidelity audio.

For the purposes of this application, the following definitions and abbreviations of terms may be used. For example, Channel=RF channel (a carrier frequency with a specific bandwidth around it).

TDMA Channel=designated timeslots of an RF channel (note that this is different from “a channel that supports TDMA” . . . which is the structure of timeslots on a channel)

Further into the description:
Symmetric TDMA Channel Structure (a.k.a., Symmetric Channel Structure)=same number of designated timeslots allocated to each TDMA Channel
Asymmetric TDMA Channel Structure (a.k.a., Asymmetric Channel Structure)=different number of designated timeslots allocated to each TDMA Channel
Logical Channel=an uplink & downlink pair of TDMA channels i.e., we have a pair (uplink and downlink) of channels that support TDMA and a logical channel is a TDMA channel on the uplink paired with a TDMA channel on the downlink).
Offset logical channel=
OLC 1=uplink TDMA Channel 1 & downlink TDMA Channel 1
OLC 2=uplink TDMA Channel 2 & downlink TDMA Channel 2
Aligned logical channel=
ALC 1=uplink TDMA Channel 2 & downlink TDMA Channel 1
ALC 2=uplink TDMA Channel 1 & downlink TDMA Channel 2

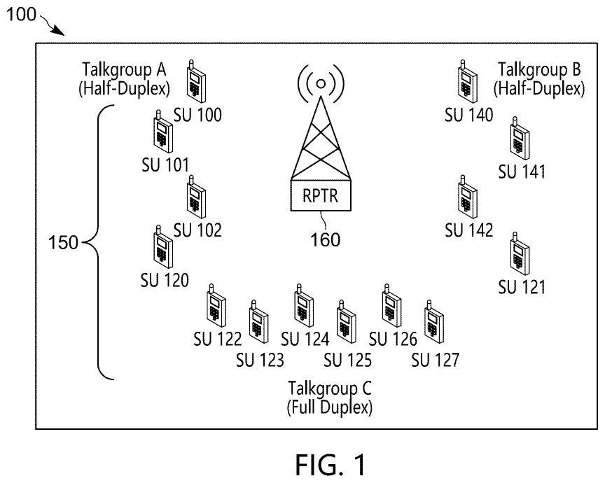

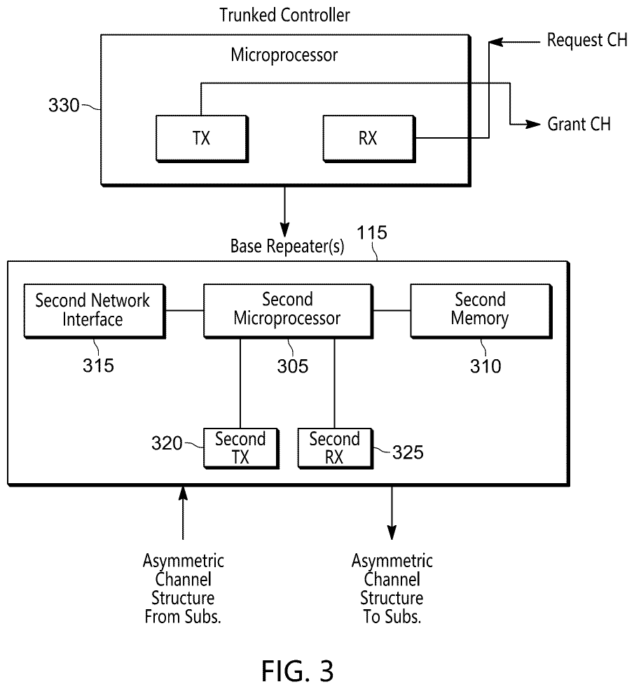

FIG. 1 is a diagram of a TDMA communication system 100 in accordance with some embodiments. The communication system 100 includes, for example, a plurality of subscriber units 150, for example SU100. SU101, SU102, SU120, SU121, SU122, SU123, SU124, SU125, SU126, SU127, SU140, SU141, SU142, and a base repeater 160 associated with a trunked controller (shown later at FIG. 3). A plurality of subscriber units may be grouped in what may also be referred to as multi-talk group, such as group C. In some embodiments, groups A and B may be half-duplex talkgroups, where the base repeater can support two independent half-duplex calls (A &B) at one instance of time and one multi-talkgroup call (C) at another instance of time. The subscriber units 150 are merely examples. In some embodiments, the communication systems may include more or fewer subscriber units than the number shown in communication system 100. The plurality of subscriber units 150, may be in several different groups, where the application of multi-talk group voice call, to be described herein is highly advantageous.

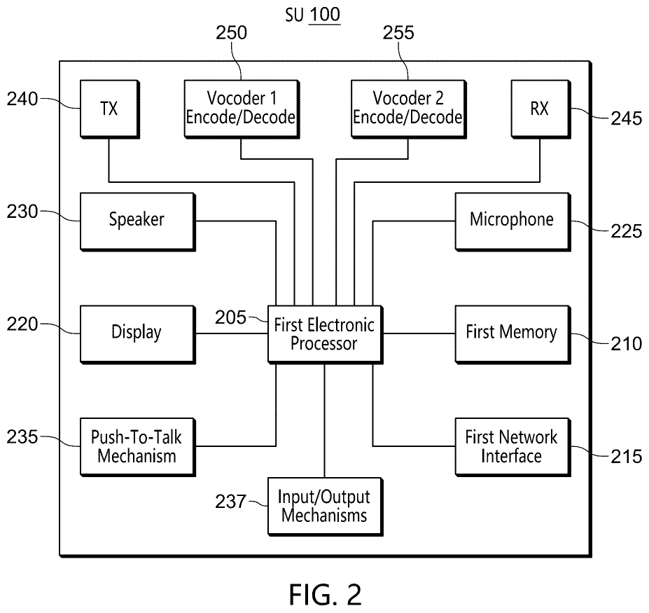

FIG. 2 is a block diagram of a subscriber unit, for example, SU100 of the TDMA communications system 100 in accordance with some embodiments. In the example shown, SU100 includes a first microprocessor 205. The first microprocessor 205 may be electrically connected to a first memory 210, a first network interface 215, a display 220, a microphone 225, a speaker 230, a push-to-talk mechanism 235, other input/output mechanisms 237, a transmitter 240, a receiver 245 and first and second vocoders 250, 255. In some examples, the SU 100 may include fewer or additional components in configurations different from that illustrated in FIG. 2. In accordance with some embodiments, the first vocoder may be a nominal fidelity vocoder and the second vocoder may be a reduced fidelity vocoder.

In some examples, the push-to-talk mechanism 235 allows a user of SU100 to initiate communication over the TDMA communication system 100. For example, when the first electronic processor 205 detects that the push-to-talk mechanism 235 is activated (for example, has been pressed), the first electronic processor 205 receives a signal from the microphone 225 of detected sound and sends vocoded data representing that sound (sometimes referred to as voice data) over the TDMA communication system (for example, such as a half-duplex communication signal). When the first electronic processor 205 detects that the push-to-talk mechanism 235 is no longer activated (for example, has been released), the first electronic processor 205 stops the communication of the voice data. However, in the embodiments described herein, a subscriber unit serving (or acting or behaving) as a primary subscriber unit during a multi-talk group call is now able to hear audio from a subscriber unit serving (or acting or behaving) as a secondary subscriber unit during the multi-talk group call, while the PTT of the primary subscriber unit is still activated, accomplished by using asymmetric channel structures on the TDMA transmissions.

In accordance with examples described later in this application, the asymmetrical TDMA channel structure allocates a higher data rate (bit per second (bps)) for primary voice in offset logical channel 1 and a lower data rate (bps) in offset logical channel 2 for secondary voice. This enables, for example, a nominal fidelity vocoder (vocoder 1) 250 for use with primary audio in offset logical channel 1 and a reduced fidelity vocoder (vocoder 2) 255 for use with secondary audio in offset logical channel 2, as will be shown and described later. Of course, as a choice of the implementer, offset logical channel 2 could have the higher data rate for primary voice and offset logical channel 2 could have the lower data rate for secondary voice.

FIG. 3 is a block diagram of a trunked controller 330 and a base repeater 115, operating in accordance with some embodiments. In the example illustrated, the trunked controller 330 receives service requests originating from subscriber units and may grant the service requests to those subscriber units, in accordance with known channel request/grant techniques used in TDMA systems. A new type of service: “Multi-Talk Group Voice Service” is provided. When the service request is granted, the trunk controller allocates one or more logical channels for the subscriber units to use. In the case of a Multi-Talk Group Voice Service grant, two logical channels are allocated at a site: one primary logical channel (uplink and downlink TDMA Channel pair) for the requestor/talker and one secondary logical channel (uplink and downlink TDMA Channel pair) for all other group members that might desire to transmit to the group while the primary talker is talking to the group.

In the example illustrated in FIG. 3, the base repeater 115 includes a microprocessor 305, also referred to as a second microprocessor 205, an input/output interface (not shown), a second memory 310, a second network interface 315, a transmitter 320, and a receiver 325.

In accordance with the embodiments and referring to FIGS. 1, 2, and 3, the base repeater 115 receives a service request, from a primary subscriber unit, the primary subscriber is granted the channel request, for a voice call with one or more secondary subscriber units.

For example, referring to SU120 (assigned as primary SU120) and a plurality of secondary subscriber units grouped as talkgroup C (TGC), an example of how the voice call may be managed is described using the asymmetric structures. For example, referring to SU120 (assigned as primary SU120) transmits a first voice call, on an uplink of offset logical channel 1 (which is a primary timeslot), to the base repeater 115, the base repeater receives the voice call on the uplink of offset logical channel 1. The base repeater then transmits (repeats) the first voice call, on a downlink of offset logical channel 1 (which is a primary logical channel), and the TGC subscriber units, including SU121, receive the voice call on the downlink of offset logical channel 1.

Next, a secondary subscriber unit 121 (SU121) transmits a secondary voice call (e.g. a response or additional information relevant to what the user of SU120 is saying) on an uplink of offset logical channel 2 (which is a secondary logical channel) to the base repeater, the base repeater receives the secondary voice call on the uplink of offset logical channel 2. The base repeater then transmits (repeats) the second voice call, on a downlink of offset logical channel 2 (which is a secondary logical channel), and the TGC subscriber units, including SU120, receive the secondary voice call on the downlink of offset logical channel 2. Note that SU120 is receiving SU121's transmission in the secondary logical channel (reduced fidelity) while it continues to transmit in the primary logical channel (nominal fidelity) and SU121 continues to receive SU120's transmission in the primary logical channel (nominal fidelity) while it transmits in the secondary logical channel (reduced fidelity). In accordance with the embodiments, the asymmetrical TDMA channel may be applied in systems where a primary, or preferred (most critical, most important, most urgent), subscriber unit transmission is capable of high fidelity audio, while a secondary subscriber unit transmission is capable of only nominal fidelity audio. Because the channel supports two contemporaneous voice streams, it can support Multi-Talk Group Voice Call.

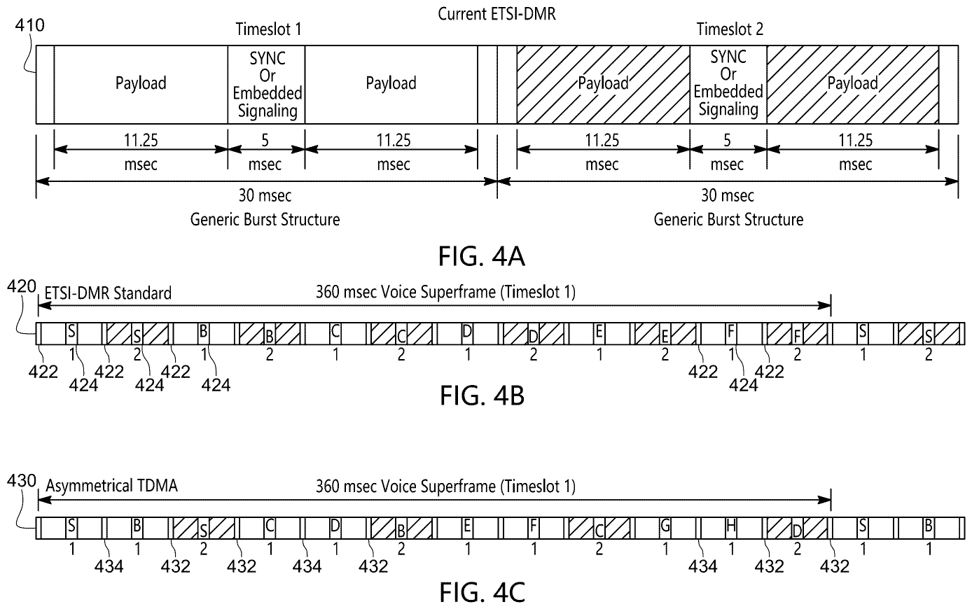

The embodiments retain the current ETSI-DMR Generic Burst Structure 410 as shown in FIG. 4A.

FIG. 4B represents a symmetrical 6:6 TDMA channel structure 420 with a total of 12 bursts with 6 bursts allocated to TDMA channel 1 and 6 bursts allocated to TDMA channel 2 according to some aspects of the invention. ETSI-DMR defines a six burst Voice Superframe spanning 360 msec, as illustrated in FIG. 4B.

FIG. 4C represents an asymmetrical 8:4 TDMA channel structure 430 with a total of twelve bursts, with 8 bursts allocated to TDMA channel 1 and 4 bursts allocated to TDMA channel 2. in accordance with some aspects of the invention. While ETSI-DMR's symmetrical 6:6 TDMA channel structure 420 allocates six bursts to each TDMA Logical Channel, the asymmetrical 8:4 TDMA channel structure 430 allocates eight bursts to one TDMA Logical Channel and four bursts to the other TDMA Logical Channel as illustrated in FIG. 4C. Note that the logical channel 1 and logical channel 2 Voice Superframes need not be aligned with any particular phasing. When the uplink channel transitions between timeslot 1 and timeslot 2 (or vice versa), there is a 12-symbol (2.5 msec) guard time 432 that cannot be used for signaling. Because there are fewer transitions between uplink timeslots 1 and 2 with the asymmetrical 8:4 TDMA channel structure, additional signaling (later referred to as the β channel) can be placed on the channel, as seen at 434.

While it is beneficial to reuse as many PDUs and FECs as possible between the symmetrical 6:6 and asymmetrical 8:4 TDMA channel structures, there are a few necessary differences which are now discussed.

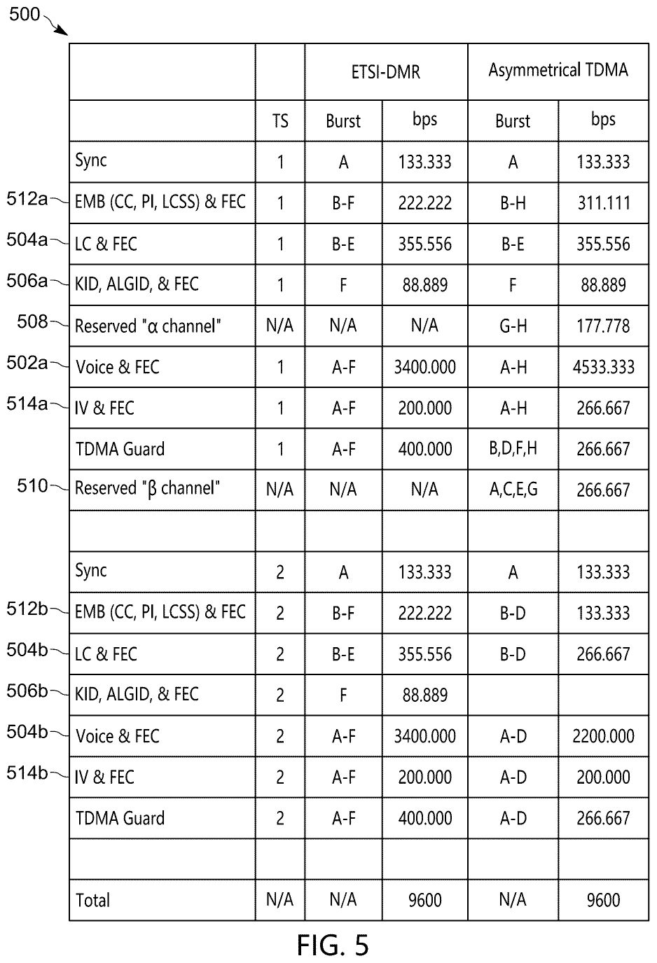

FIG. 5 shows a table 500 that compares how bits are allocated in the ETSI-DMR symmetrical TDMA channel structure with how they are allocated in the Asymmetrical TDMA channel structure.

### Voice & FEC Table 500, (Rows 502a, 502b)

Most significantly at 502a, 502b, the ETSI-DMR symmetrical TDMA channel allocates 3400 bps for voice to each logical channel when encryption is used. The asymmetrical TDMA channel structure allocates 4533.333 bps for voice in logical channel 1 (time slot 1) and 2200 bps in logical channel 2 (time slot 2). This enables, for example, an EnCodec (Meta) 3 kbps AI-Based vocoder for use with primary audio in logical channel 1 and an EnCodec (Meta) 1.5 kbps AI-Based vocoder for use with secondary audio in logical channel 2. These are just example vocoders: many exist from which to choose. E.g., the Lyra v2 (Google) 3.2 kbps AI-Based vocoder appears to offer much higher fidelity when compared with AMBE+2 and could be used with primary audio in logical channel 1. Hence, the mainline primary talker uses a nominal fidelity primary vocoder in logical channel 1 and other users that need to talkback or interrupt the primary talker use a reduced fidelity secondary vocoder in logical channel 2.

### LC & FEC (Table 500, Row 504a, 504b)

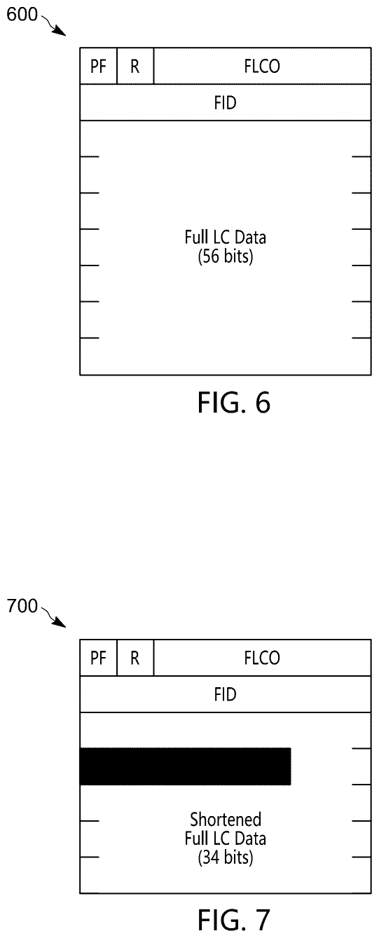

FIG. 6 and FIG. 7 represent link control message formats for LC & FEC 504 from Table 500 of FIG. 5. FIG. 6 represents a full message format 600 and FIG. 7 represents a shortened message format 700. Each of the full message format 600 and shortened message format 700 includes a protect flag (PF), a “reserved” field (not presently used for anything), a full link control opcode (FLOC) and a feature set ID (FID). ETSI-DMR defines a 72 bit Link Control PDU, which continues to be used in logical channel 1 of the Asymmetrical TDMA channel (voice bursts B-E only). While bursts B-E may provide for “best mode”, bursts C-F, D-G, E-H, C & E-G, C & F-H, D and F-H, are all possibilities, for example. However, the KID, AlgID, alpha channel would need to be relocated accordingly.

A 5-bit checksum is appended and the 77-bit result is FEC encoded with BPTC(128,77) using the Variable Length BPTC for embedded signaling defined in ETSI-DMR part 1. That 128-bit result is split into four 32-bit pieces and embedded in voice bursts B, C, D, and E.

Because logical channel 2 of the Asymmetrical TDMA channel structure has only four bursts (three non-A voice bursts) in the 360 msec voice superframe, a Shortened Link Control PDU is defined which requires only three bursts (voice bursts B-D) to transport.

A 5-bit checksum is appended and the 55-bit result is FEC encoded with BPTC(96,55) using the Variable Length BPTC for embedded signaling defined in ETSI-DMR part 1. That 96-bit result is split into three 32-bit pieces and embedded in voice bursts B, C, and D.

There is some interdependency between the Full Link Control PDU in timeslot 1 and the Shortened Full Link Control PDU in timeslot 2 of the Asymmetrical TDMA channel structure.

### KID, ALGID, & FEC (Table 500, Rows 506a, 506b)

The DMRA defines a PDU to transport an encryption key identifier (KID) and encryption algorithm identifier (ALGID) which uses the single burst embedded LC, defined by ETSI-DMR. This PDU continues to be used in logical channel 1 of the Asymmetrical TDMA channel (voice burst F). Because logical channel 2 of the Asymmetrical TDMA channel structure has only four bursts, there is no room available to transport KID and ALGID in logical channel 2; therefore, interdependency between logical channel 1 and logical channel 2 with respect to encryption parameters has been introduced, which is discussed later.

### α Channel (Table 500, Row 508)

Because logical channel 1 of the Asymmetrical TDMA channel structure has eight bursts, but only six bursts are needed for sync, LC, and KID/ALGID, two bursts (2×32=64 bits) are available to carry additional embedded signaling (64 bits/0.36 seconds=177.778 bps) within logical channel 1.

### β Channel (Table 500, Row 510)

As previously mentioned, there are four fewer transitions between uplink timeslots 1 and 2 (and vice versa); therefore, additional signaling can be placed on the channel where uplink guard time was formerly present. This additional signaling is 4×24=96 bits every 360 msec, or 266.667 bps. For example, a 96-bit CSBK with BPTC(196,96) FEC is 196 bits; therefore, by using Motorola Solution's MOTOTRBO High Efficiency Data, a transmitting radio can handily send a location update as frequently as once per second in the β Channel. Embedding location may be important because Multi-Talk Group Voice Calls are anticipated to have very long duration (hours to days) with very long PTT transmissions and the subscriber users may rely on subscriber location data to identify personnel that are in or have entered a dangerous area.

### TACT & FEC

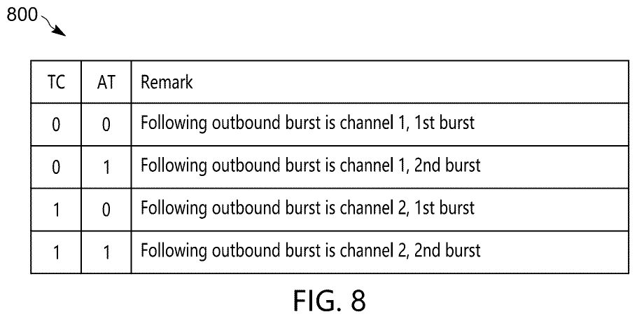

Present only on the downlink are the TACT bits, that is, the TDMA Channel and Access Type indication bits, protected with a Hamming(7,4) FEC, as defined by the ETSI-DMR standard. The TACT bits are repurposed for the asymmetrical TDMA channel structure to more precisely identify the sequence of bursts on the channel as outlined in Table 800 of FIG. 8. With ETSI-DMR symmetrical channel structure, the TACT sequence is: 0x-1x-0x-1x-0x-1x- . . .

With the Asymmetrical TDMA channel structure,
When TDMA Channel 1 is the primary logical channel, the TACT sequence is:
00-01-10-00-01-10-
When TDMA Channel 2 is the primary logical channel, the TACT sequence is:
10-11-00-10-11-00- . . .

Note that the Hamming distance between the TACT bits indicating TDMA Channel 1 2nd burst and TDMA Channel 2 1st burst is 2. Also, the Hamming distance between the TACT bits indicating TDMA Channel 2 2nd burst and TDMA Channel 1 1st burst is 2.

The channel structure could be static (e.g., TDMA Channel 1 is always primary (8 voice bursts) and TDMA Channel 2 is always secondary (4 voice bursts)), but there may be situations where a dynamic channel structure is beneficial (e.g., change TDMA Channel 1 from primary to secondary and change TDMA Channel 2 from secondary to primary). When transitioning the channel from one structure to the other, the following TACT sequences would be used:
TDMA Channel 1 primary to TDMA Channel 2 primary:
   Expected sequence: 00-01-10-00-01-10-00-01-10- . . .
   Received sequence: 00-01-10-11-00-10-11-00-10-11-00- . . .
TDMA Channel 2 primary to TDMA Channel 1 primary:
   Expected sequence: 10-11-00-10-11-00-10-11-00- . . .
   Received sequence: 10-11-00-01-10-00-01-10-00-01-10- . . .
      At the point of transition, the bold digits are a Hamming distance of 2 from the expected value given the sequence leading up to it. E.g., in the first case, a “00” (TDMA Channel 1 1st burst) is expected, but a “11” (TDMA Channel 2 2nd burst) is received. E.g., in the second case, a “10” (TDMA Channel 2 1st burst) is expected, but a “01” (TDMA Channel 1 2nd burst) is received. Maximizing the Hamming distance in this way increases confidence that a channel structure change is happening and that the received sequence isn't a consequence of a random, uncorrectable bit error.

### EMB (CC, PI, LCSS) & FEC (Table 500, Rows 512a, 512b)

There are no differences between ETSI-DMR and Asymmetrical TDMA channel structure with respect to EMB signaling. Every non-A voice burst contains EMB.

### IV & FEC (Table 500 Rows 514a, 514b)

DMRA defines a mechanism to transport the encryption Initialization Vector & FEC by “stealing” 12 bits from every voice burst. This scheme continues to be used in Logical Channel 1 of the Asymmetrical TDMA channel.
6 bursts of ETSI-DMR carries 72 bits (200 bps) in each Logical Channel.
8 bursts of Asymmetrical timeslot 1 carries 96 bits (266.667 bps)
   Since Logical Channel 2 of the Asymmetrical TDMA channel has only 4 bursts, 18 bits will be “stolen” from every voice burst.
4 bursts of Asymmetrical Logical Channel 2 carries 72 bits (200 bps).

### Logical Channels 1 and 2 Interdependency

As mentioned previously, sacrifices were made with the Shortened Full Link Control PDU and the KID/ALGID PDU. To address this, interdependency is introduced between Logical Channels 1 & 2 of the Asymmetrical Channel Structure. The two calls on Logical Channels 1 & 2, by their nature, are related: there is a primary talker and a responder (or secondary) talker within the same talkgroup. Before a user may respond as a secondary talker, they must first be receiving the primary talker's voice call. As such, the responder is aware of a) the Target Group Address, and b) the KID/ALGID being used for the call. All subscribers on the channel understand this relationship between logical channels 1 & 2 and there is no need to explicitly signal these Information Elements in the secondary logical channel.

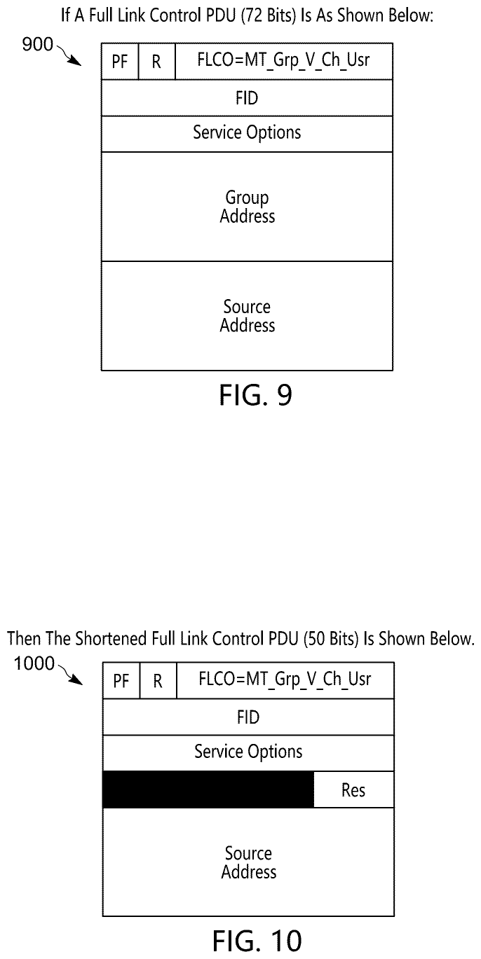

FIGS. 9 and 10 show full & shortened link control signaling for a multi-talker group voice call in accordance with some aspects of the invention.
If a Full Link Control PDU (72 Bits) is as shown in FIG. 9 at 900:
Then the Shortened Full Link Control PDU (50 bits) is as shown in FIG. 10 at 1000.
Both the Full Link Control PDU 900 and Shortened Full Link Control PDU 1000 contain a protect flag (PF), a reserved field (R), a full link control opcode (FLCO), a feature set ID (FID), and a service options field. As shown in FIG. 10, a target group address is not included in the Shortened Full Link Control PDU (secondary logical channel) and is learned from the Full Link Control PDU (primary logical channel).
The KID/ALGID is not transmitted in the secondary logical channel; instead, it is learned from the F burst in the primary logical channel.

### Treatment of Priority and Secondary Audio Streams throughout the System

By introducing the concepts of nominal fidelity primary audio and reduced fidelity secondary audio on the radio channel, the system identifies primary audio streams through various methods, such as a) the radio to request/begin a Multi-Talk Group Voice Call, b) a configured group member (e.g., a “controller” overseeing operations, or a particular radio/user that is certified to enter a very hazardous environment (hypergolic fuel handling)), c) special PTT or button combination sequence, etc. Once the primary audio user has been identified, the system routes primary audio and secondary audio throughout the system (between sites) ensuring that nominal fidelity audio is transported on a primary logical channel and reduced fidelity audio is transported on a secondary logical channel at each site.

The Multi-Talk Group Voice Call feature/capability has applicability to not only industrial environments but also live TV remote broadcasts (studio links), live concert venues (stage management), sporting events, to name a few.

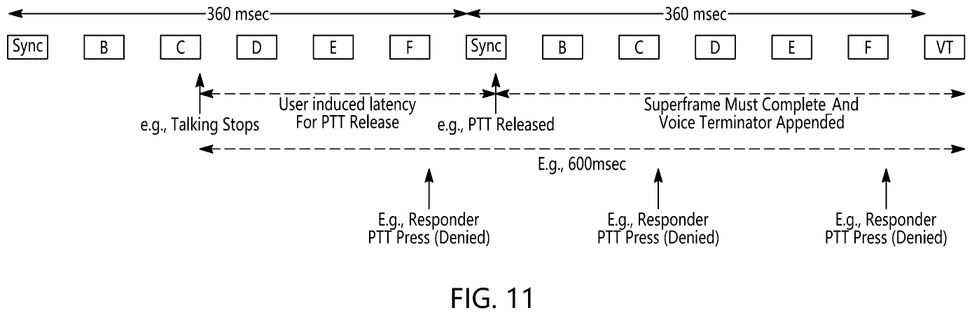

Additional examples follow in accordance with various embodiments. As mentioned previously, the PTT radio operations occur at a very rapid pace with many back-and-forth PTT presses and releases containing short voice segments. FIG. 11 represents an example of a series of denied PTT presses throughout an ETSI-DMR voice superframe (360 msec duration). It has been observed that subscriber users: a) sometimes respond with their own PTT press after the original talker had stopped talking but before the original talker had released their PTT (see illustration of FIG. 11), and b) sometimes respond after the original talker has released their PTT but before the radio has padded out the ETSI-DMR voice superframe (360 msec duration) to completion and appended a voice terminator to end its transmission (see illustration of FIG. 11). When pressing the PTT slightly early, the subscriber unit locally rejects the PTT press, plays a bad tone (denial or reject tone), forces the user to release their PTT switch, wait a brief moment, and retry their PTT press—all of which consume the subscriber unit user's time. While user training in the proper operation of the device is preferred, there are cases where user training is not considered acceptable, and thus another alternative approach is desired.

Several features are considered desirable for a solution:

While a first subscriber unit is transmitting to a target talkgroup, it shall be possible for a second subscriber unit belonging to the target talkgroup to begin its own transmission and talk back to the first subscriber unit. This procedure must minimize access latency and not cause the first subscriber unit to dekey.
As a matter of practicality, there will be one primary talker and usually only one interrupter; however, there may be some scenarios and race conditions where several, perhaps up to about four, interrupters nearly simultaneously try to begin their own transmission, although that is a rare event.
All talkgroup members shall receive both the first and second subscriber units' transmissions.
The solution advantageously exists entirely “on-prem”.

### Solution Description

High Level Introduction. The disclosed embodiments provide for a talkgroup voice call where more than one subscriber unit may simultaneously transmit to all talkgroup members. A system resource allocator assigns one timeslot pair, a Logical Channel, (i.e., an uplink timeslot on which to transmit to a repeater and a downlink timeslot on which to receive from a repeater) per actively transmitting subscriber unit (e.g., with PTT pressed) and one timeslot pair, a Logical Channel, for all non-transmitting subscriber units belonging to a talkgroup to share (up to a maximum of N assigned timeslot pairs per repeater) on a repeater. The timeslot pair assigned to all non-transmitting subscriber units remains idle and in Call Hangtime (i.e., reserved for a specific talkgroup) until one of the non-transmitting subscriber units initiates a transmission (i.e., the timeslot is pre-allocated for “the next” transmission to the talkgroup, thus minimizing transmission setup latency). All subscriber units belonging to the talkgroup receive all active downlink timeslots not containing their own repeated transmission, decrypt the audio streams, de-vocode the audio streams, sum/mix the audio streams (optionally, attenuating some streams with respect to other streams for ease of human understanding), and render the audio to the subscriber units' respective users.

### DETAILED DESCRIPTION OF THE DISCLOSED EMBODIMENTS

Note that the embodiments are described in terms of 2:1 TDMA, but is extensible to any N:1 TDMA ratio, where N indicates the number of TDMA channels supported by an RF channel. When N>2, there may be 2 or more primary logical channels or 2 or more secondary logical channels, or some appropriate combination of each.

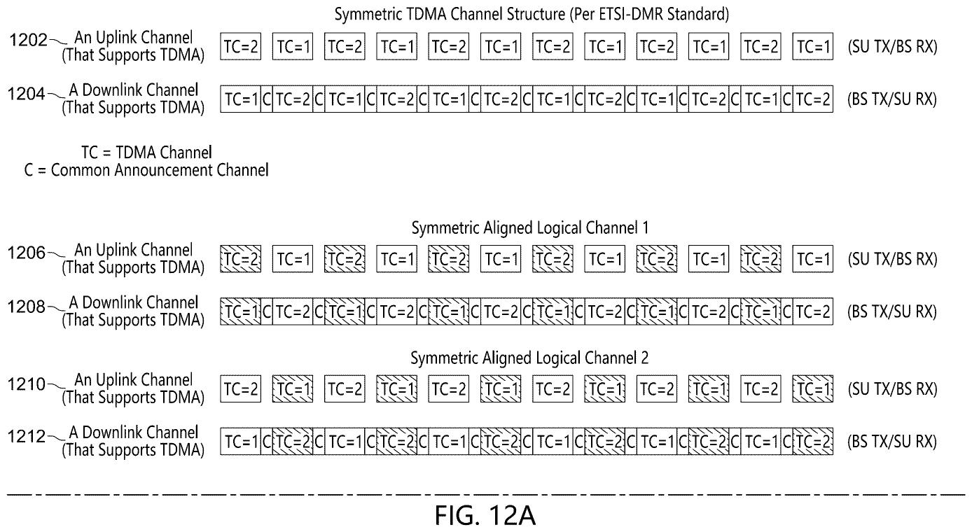

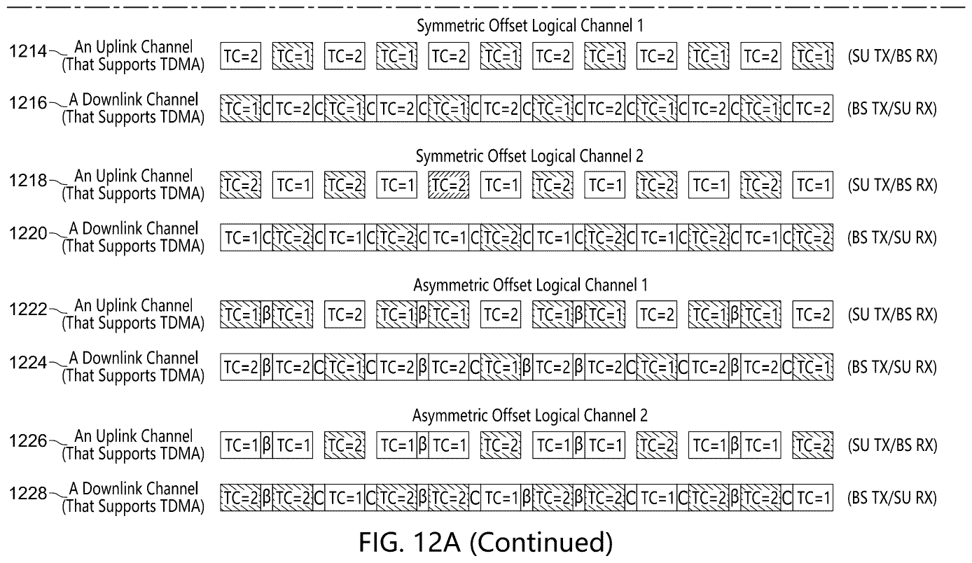

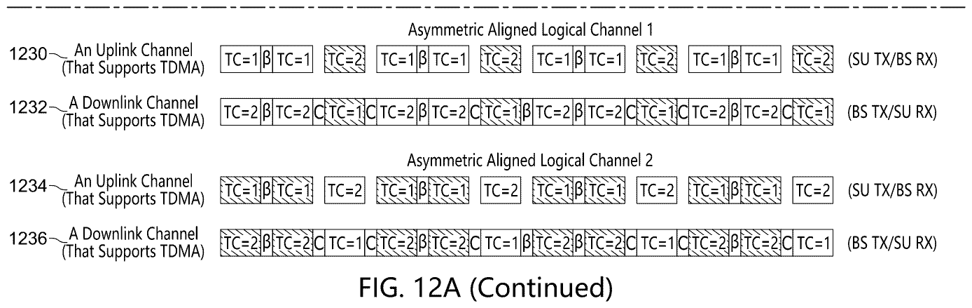

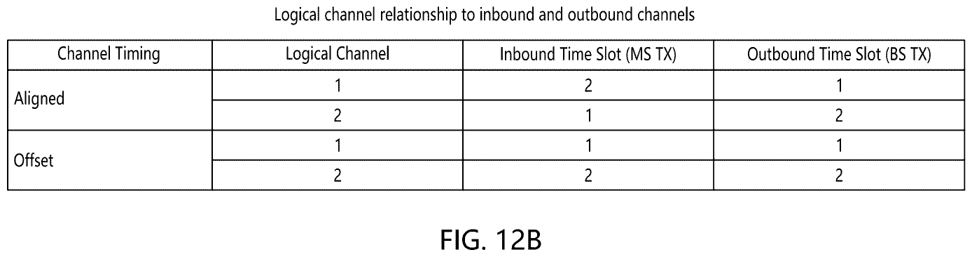

FIG. 12A represents different types of usable logical channels based on the channel timing combinations of FIG. 12B in accordance with some aspects of the invention. A symmetric channel structure (per ETSI-DMR standard) is shown with an uplink channel between a transmitting subscriber unit and a receiving base station (base repeater) at uplink RF channel at 1202 and a downlink RF channel being transmitted from the base station to the receiving subscriber unit at 1204. Each of the RF channels 1202, 1204 is divided up into two TDMA channels, and logical channels are formed by a pairing of uplink TDMA channel with a downlink TDMA channel.

At RF channels 1206, 1208 an uplink TDMA channel 2 (TC2) is paired with a downlink TDMA channel 1 (TC1) and the pairing is referred to as logical channel 1 when using aligned channel timing on a symmetric channel.

At RF channels 1210, 1212 an uplink TDMA channel 1 (TC1) is paired with a downlink TDMA channel 2 (TC2) and the pairing is referred to as logical channel 2 when using aligned channel timing on a symmetric channel.

At RF channels 1214, 1216 an uplink TDMA channel 1 (TC1) is paired with a downlink TDMA channel 1 (TC1) and the pairing is referred to as logical channel 1 when using offset channel timing on a symmetric channel.

At RF channels 1218, 1220 an uplink TDMA channel 2 (TC2) is paired with a downlink TDMA channel 2 (TC2) and the pairing is referred to as logical channel 2 when using offset channel timing on a symmetric channel.

At RF channels 1222, 1224 an uplink TDMA channel 1 (TC1) is paired with a downlink TDMA channel 1 (TC1) and the pairing is referred to as logical channel 1 when using offset channel timing on an asymmetric channel.

At RF channels 1226, 1228 an uplink TDMA channel 2 (TC2) is paired with a downlink TDMA channel 2 (TC2) and the pairing is referred to as logical channel 2 when using offset channel timing on an asymmetric channel.

At RF channels 1230, 1232 an uplink TDMA channel 2 (TC2) is paired with a downlink TDMA channel 1 (TC1) and the pairing is referred to as logical channel 1 when using aligned channel timing on an asymmetric channel.

At RF channels 1234, 1236 an uplink TDMA channel 1 (TC1) is paired with a downlink TDMA channel 2 (TC2) and the pairing is referred to as logical channel 2 when using aligned channel timing on an asymmetric channel.

FIG. 12B is a Table from ETSI TS 102 361-1-V2.6.1 (a.k.a., ETSI-DMR Part 1) outlining logical channel relationship to inbound and outbound channels in accordance with some aspects of the invention.

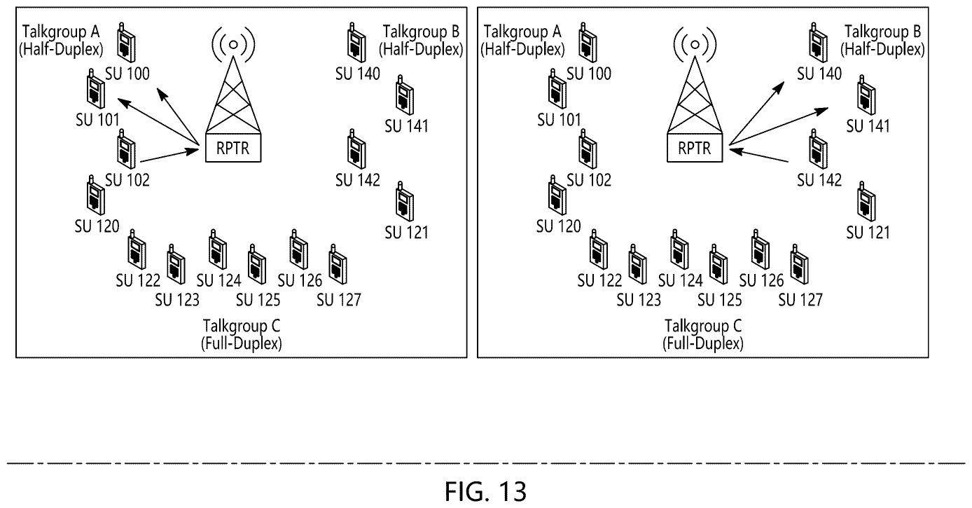

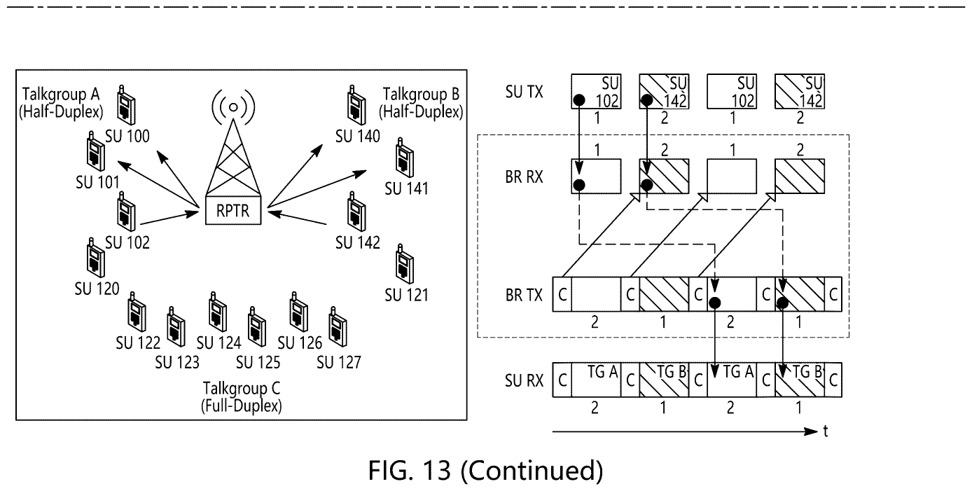

FIG. 13 is a diagram of a communication system operating in accordance with some aspects of the invention. At a first instance of time, the base repeater may support two independent half-duplex talkgroup calls. In the communication diagram of FIG. 13 a first voice call is sent from a first subscriber unit (SU102) to a first talkgroup (TGA), and a second voice call is sent from a second subscriber unit (SU142) to a second talkgroup (TGB) as follows. Subscriber unit 102 (SU102) transmits a first voice call on offset logical channel 1, that is, on the uplink of offset logical channel 1, to the base repeater, the base repeater receives the first voice call on the uplink of offset logical channel 1. The base repeater then transmits (repeats) the first voice call, on the downlink of offset logical channel 1, to the first talkgroup (TGA) comprising SU100 and SU101, and the TGA subscriber units receive the first voice call on the downlink of offset logical channel 1.

In the above communication, subscriber unit 142 (SU142) transmits the second voice call on the uplink of offset logical channel 2 to the base repeater, the base repeater receives the second voice call on the uplink of offset logical channel 2. The base repeater then transmits (repeats) the second voice call, on the downlink of offset logical channel 2, to the second talkgroup (TGB) comprising SU140 and SU141, and the TGB subscriber units receive the second voice call on the downlink of offset logical channel 2.

Hence, the first subscriber unit can transmit a voice call to a first talkgroup and a second subscriber unit can transmit a voice call to a second talkgroup on different logical channels of a base repeater, but the first and second subscriber units, while transmitting, are unable to receive audio from any other subscriber unit because the system is operating in a half-duplex fashion.

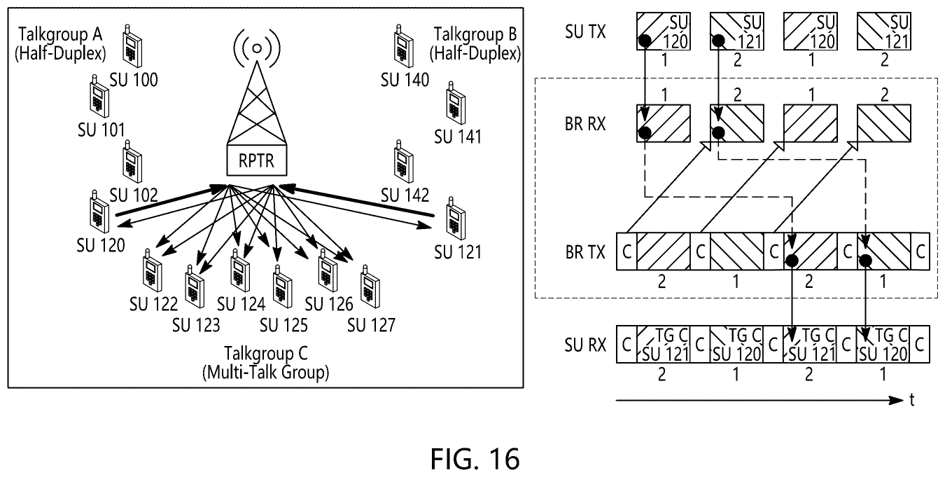

At a second instance of time, the base repeater may support one multi-talk group voice call. In the communication diagram of FIG. 16 a first voice call of the multi-talk group voice call is sent from a first subscriber unit (SU120) to a talkgroup (TGC), and a second voice call of the multi-group voice call is sent from a second subscriber unit (SU121) to the talkgroup (TGC) as follows. Subscriber unit 120 (primary SU120) transmits a first voice call of the multi-group voice call on offset logical channel 1, that is, on the uplink of offset logical channel 1, to the base repeater, the base repeater receives the first voice call on the uplink of offset logical channel 1. The base repeater then transmits (repeats) the first voice call, on the downlink of offset logical channel 2, to the talkgroup C (TGC) subscriber units comprising SU121-SU127, and the TGC subscriber units receive the first voice call of the multi-talk group voice call, on the downlink of offset logical channel 2.

In the above communication, the secondary subscriber unit 121 (SU121) transmits a secondary voice call of the multi-group voice call on the uplink of offset logical channel 2 to the base repeater, the base repeater receives the secondary voice call on the uplink of offset logical channel 2. The base repeater then transmits (repeats) the second voice call, on the downlink of offset logical channel 1, to the talkgroup C (TGC) subscriber units comprising SU120 & SU122-SU127 and the TGC subscriber units receive the secondary voice call of the multi-group voice call on the downlink of offset logical channel 1.

Hence, the primary subscriber, SU120,can hear audio from the secondary subscriber unit SU121, by monitoring the downlink of offset logical channel 1, while still having the primary PTT pressed. The secondary subscriber unit, SU121, can hear audio from the primary subscriber unit, SU120, by monitoring the downlink of offset logical channel 2, while having the secondary PTT pressed. The non-transmitting members of a group, SU122-SU127,can hear audio from both the primary and secondary subscriber units by monitoring the downlinks of offset logical channels 1 & 2.

### Multi-Talk Group Voice Call

Similar to a half-duplex talkgroup call, the Multi-Talk Group Voice Call uses a 24-bit Talkgroup ID (TGID) to identify the group. The Multi-Talk Group Voice Call TGID is configured in a Capacity Max Radio Management database as Multi-Talk “Disallowed”, “Allowed”, or “Mandatory”. Radio Management (RM) provisions the Capacity Max Trunk Controller (TC) and Subscriber Units (SU) accordingly.

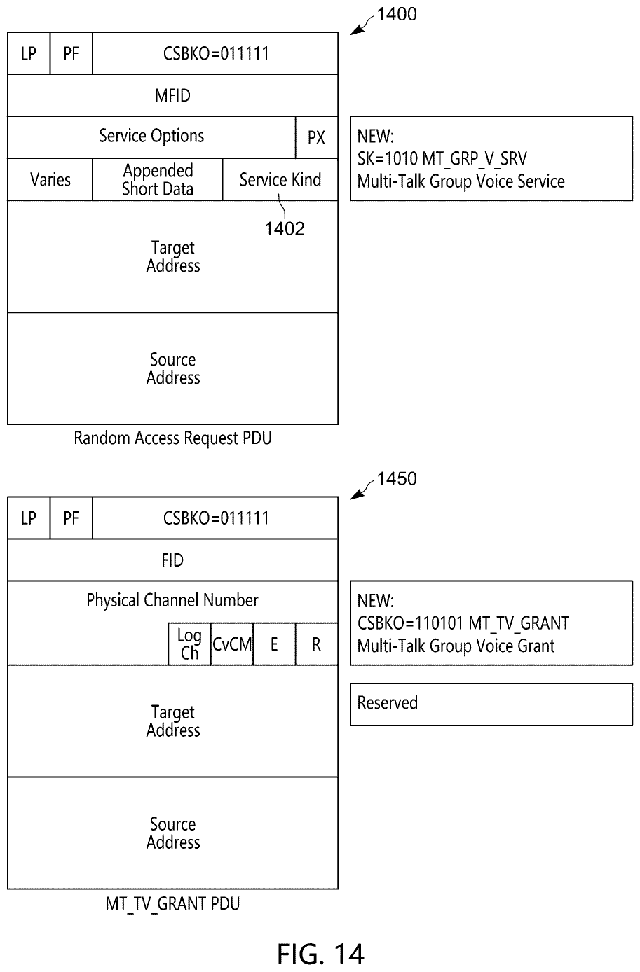

Multi-talk Group Voice Call: FIG. 14 represents a Multi-Talk Group Voice Service Request and a Multi-Talk Talkgroup Voice Grant in accordance with some aspects. A subscriber unit begins a Multi-Talk Group Voice Call by transmitting a Random Access Request 1400 (specifically, a new/proposed Multi-Talk Group Voice Service Request) on a Control Channel. Such a request is identical to a Group Voice Service Request, but with a new “Service Kind” 1402 Information Element (IE) indicating “Multi-Talk Group Voice Service Request”. Alternatively, a standard Group Voice Service Request could be used, and the Trunk Controller's provisioning indicates that the group is a Multi-Talk group. In response to receiving a Multi-Talk Group Voice Service Request 1400, the Trunk Controller sets up the call similar to a standard Talkgroup call and transmits a call grant 1450 on the Control Channel. The main difference between a standard talkgroup call and a Multi-Talk Group Voice Call is that the Trunk Controller allocates an entire repeater to a Multi-Talk Group Voice Call while a standard talkgroup call only requires one Logical Channel. The call requestor is initially explicitly assigned to use one uplink TDMA Channel and all other subscriber units are assigned to use another uplink TDMA Channel (if and when needed).

When a repeater has more than two timeslots (e.g., N:1 TDMA, N>2), then optionally, the trunk controller could identify which n of N timeslots are allocated to the Multi-Talk Group Voice Call. The Multi-Talk Talkgroup Voice Grant 1450 is shown at FIG. 14. The physical & logical channel numbers identified in the message apply to the call requestor (i.e., first talker), and all other talkgroup members are initially assigned to use the next available timeslot of the allocation.

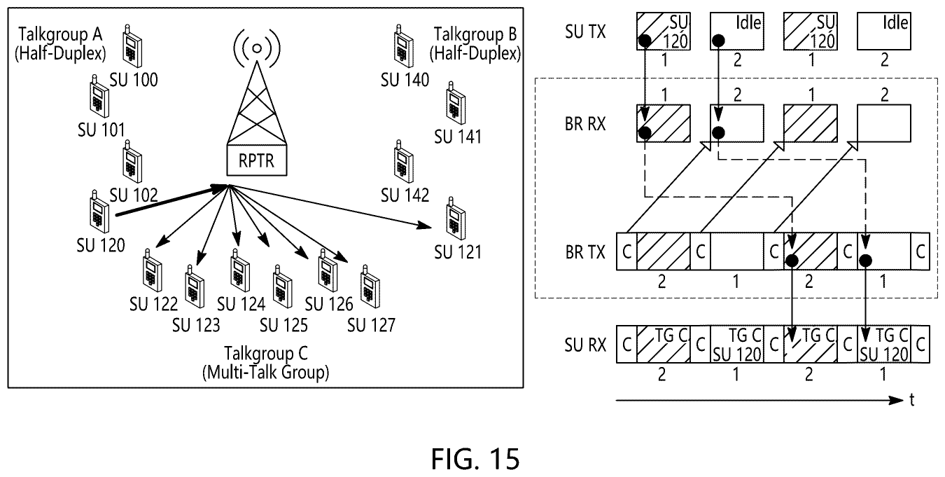

FIGS. 15, 16, 17, 18, and 19 with accompanying description, illustrate the life cycle of a typical Multi-Talk Group Voice Call in accordance with some aspects.

Referring to FIG. 15, SU 120 requests a Multi-Talk Group Voice Call for Talkgroup C and the call is successfully set up. At this time:
SU 120 is using ETSI-DMR offset Logical Channel 1 (transmitting in uplink TDMA Channel 1 and monitoring downlink TDMA Channel 1)
The repeater is transmitting Voice Call Hangtime in downlink TDMA Channel 1 (because uplink TDMA Channel 2 is idle)
SU 121-127 are pre-assigned (via the grant) to use ETSI-DMR offset Logical Channel 2 (uplink TDMA Channel 2) in the event that any one of them need to transmit
SU 121-127 are receiving all downlink timeslots and rendering received audio to the subscribers' user
   at this time, only SU 120 is transmitting audio

Referring to FIG. 16, SU 121's user has critical/urgent information for SU 120's user and must transmit. The SU 121 user presses PTT and SU 121 begins transmitting on uplink TDMA Channel 2 (optionally, transmission trunking or the well-known Capacity Max Call Hangtime arbitration procedure could be applied to uplink TDMA Channel 2 to mitigate collisions). At this time:
SU 120 is using ETSI-DMR offset Logical Channel 1 (transmitting in uplink TDMA Channel 1 and receiving SU 121's transmission in downlink TDMA Channel 1)
SU 121 is using ETSI-DMR offset Logical Channel 2 (transmitting in uplink TDMA Channel 2 and receiving SU 120's transmission in downlink TDMA Channel 2)
SU 122-127 are receiving SU 120 and SU 121 in downlink TDMA Channels 1 and 2 respectively, mixing the received audio and rendering the mixed audio to the subscribers' user
With an ETSI-DMR 2:1 TDMA system, there are no timeslots available to accommodate additional transmitters

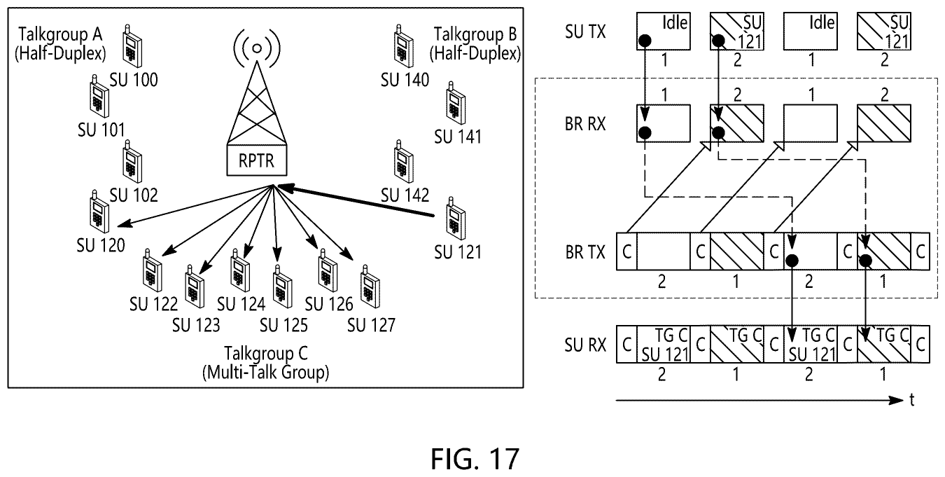

At FIG. 17, the user of SU 120 heard at least a portion of SU 121's transmission and has decided that one appropriate action is to dekey. At this time:
SU 121 is using ETSI-DMR offset Logical Channel 2 (transmitting in uplink TDMA Channel 2 and monitoring downlink TDMA Channel 2)
The repeater is transmitting Voice Call Hangtime in downlink TDMA Chanel 2 (because uplink TDMA Channel 1 is idle)
SU 120 and 122-127 independently and autonomously determine that uplink TDMA Channel 1 is idle and could be used in the event that any one of them need to transmit
SU 120 & 122-127 are receiving all downlink timeslots and rendering received audio to the subscribers' user
   at this time, only SU 121 is providing audio.

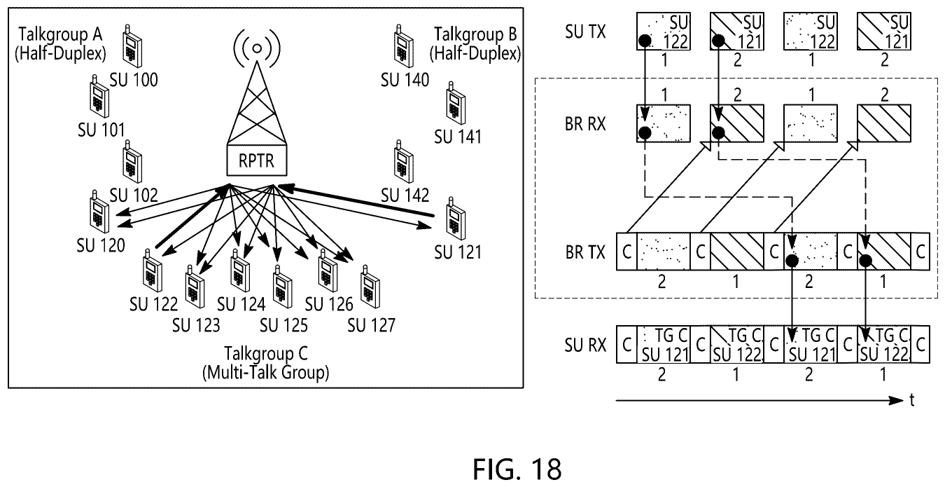

Referring to FIG. 18, SU 122's user has critical/urgent information for SU 121's user and must transmit. The SU 122 user presses PTT and SU 122 begins transmitting in uplink TDMA Channel 1 (optionally, transmission trunking or the well-known Capacity Max Call Hangtime arbitration procedure could be applied to uplink TDMA Channel 1 to mitigate collisions). At this time:
SU 122 is using ETSI-DMR offset Logical Channel 1 (transmitting in uplink TDMA Channel 1 and receiving SU 121's transmission in downlink TDMA Channel 1)
SU 121 is using ETSI-DMR offset Logical Channel 2 (transmitting in uplink TDMA Channel 2 and receiving SU 122's transmission in downlink TDMA Channel 2)
SU 120 & 123-127 are receiving SU 122 and SU 121 in downlink TDMA Channels 1 & 2 respectively, mixing the received audio and rendering the mixed audio to the subscribers' user
With an ETSI-DMR 2:1 TDMA system, there are no timeslots available to accommodate additional transmitters.

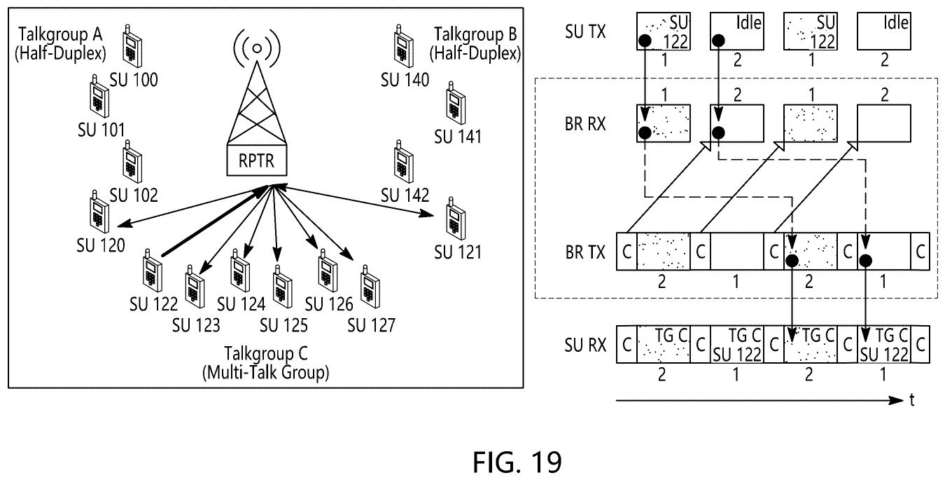

Referring to FIG. 19, The user of SU 121 heard at least a portion of SU 122's transmission and has decided that one appropriate action is to dekey. At this time:
SU 122 is using ETSI-DMR offset Logical Channel 1 (transmitting in uplink TDMA Channel 1 and monitoring downlink TDMA Channel 1)
The repeater is transmitting Voice Call Hangtime in TDMA Channel 1 (because uplink TDMA Channel 2 is idle)
SU 120 & 121 & 123-127 independently and autonomously determine that uplink TDMA Channel 2 is idle and could be used in the event that any one of them need to transmit
SU 120 & 121 & 123-127 are receiving all downlink timeslots and rendering received audio to the subscribers' user
at this time, only SU 122 is providing audio

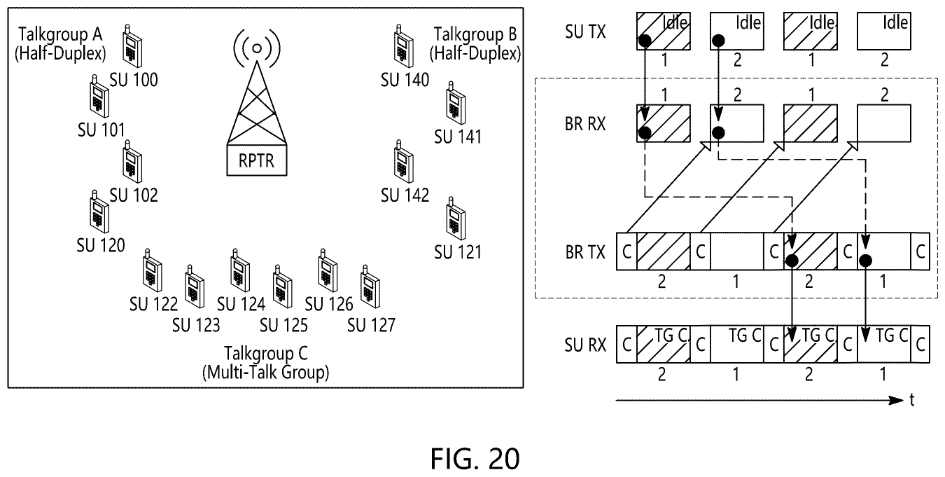

Referring to FIG. 20, the user of SU 122 dekeys. At this time:
The repeater is transmitting Voice Call Hangtime on downlink TDMA Channels 1 & 2
SU 120-127 determine that both uplink TDMA Channels 1 & 2 are idle and either uplink TDMA Channel could be used in the event that any one of them need to transmit during the Call Hangtime period.
After the period of Call Hangtime expires, the repeater dekeys and SU 120-127 move back to the control channel, per standard procedures.

While FIG. 15-FIG. 20) show a symmetric channel, an asymmetric channel could also be used in the same manner.

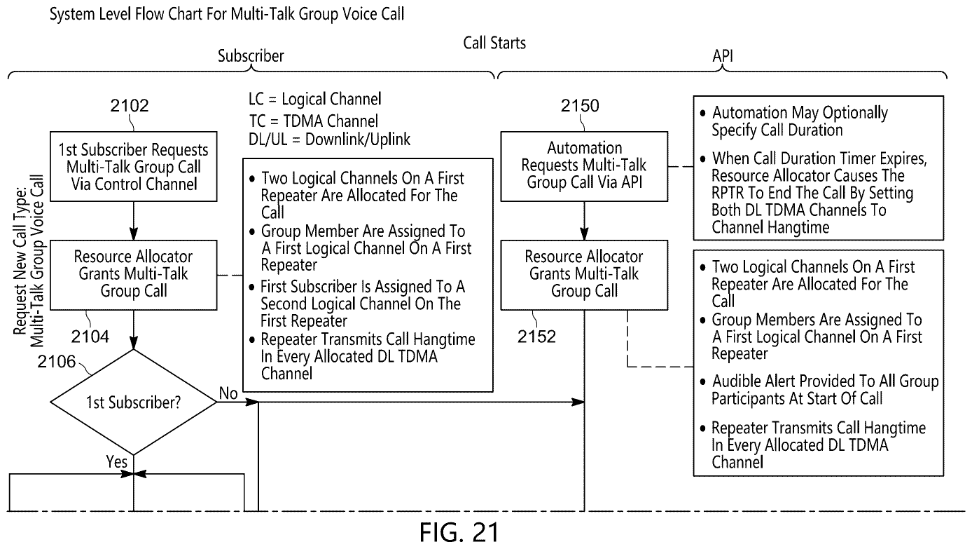

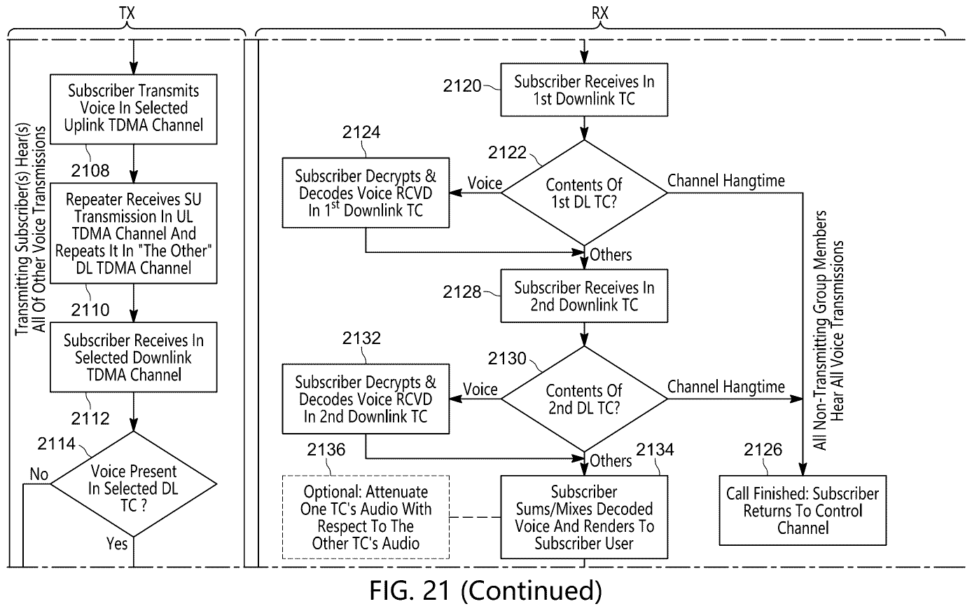

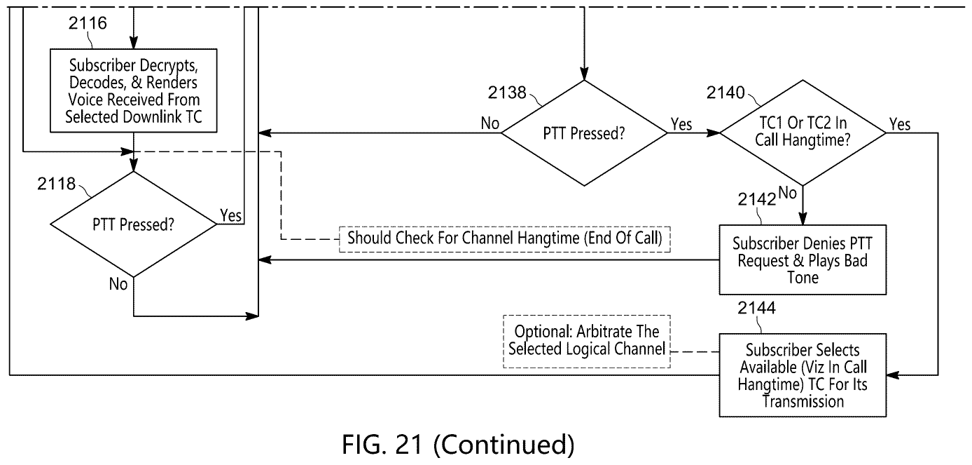

FIG. 21 is a system level flow chart for multi-talk group voice call. The call starts with either a subscriber request or automatically via an API. At 2102 a subscriber requests a multi-talk group call via a control channel. A resource allocator grants the multi-talk group call at 2104. The multi-talk group call grant at 2104 comprises allocating two logical channels on a first repeater for the call, assigning group members to a first logical channel on a first repeater, assigning a first subscriber to a second logical channel on the first repeater, and the repeater transmitting call hangtime in every allocated downlink TDMA channel.

The flow chart moves to 2106 to determine if the requester is a first subscriber of the call request (in other words the subscriber that made/initiated the request). If yes, then the flowchart moves to a transmit branch which begins at 2108 with the subscriber transmitting voice in a selected uplink TDMA channel. The repeater then receives the subscriber unit information in the uplink channel and repeats it in the other downlink TDMA channel at 2110. The flowchart proceeds to 2114 to determine if voice is present in the selected downlink TDMA channel. If yes, then the subscriber decrypts, decodes and renders the voice received from selected downlink TDMA channel at 2116.

A determination is made at 2118 as to whether the PTT button is pressed. If yes, then return to 2108, thereby repeating burst by burst. If the PTT is not pressed at 2118, then proceed to 2120 where the subscriber receives (at time slot 1 and time slot 2 the burst in the first downlink TDMA channel on the receive side.

A determination is made at 2122 as to the contents of the burst in the first downlink TDMA channel. If the content is voice, then the subscriber decrypts and decodes the voice received in the first downlink TDMA channel. If the content is channel hangtime at 2122, then the call is finished and the subscriber returns to the control channel at 2126. If the content is something other than voice or hangtime, then the subscriber receives in the second downlink TDMA channel at 2128 (subscriber receives at time slot 1 and time slot 2). The contents of the second downlink TDMA channel are checked at 2130.

If the content is voice, then the subscriber decrypts and decodes the voice received in the second downlink TDMA channel at 2132. The subscriber then sums (mixes) the decoded voice (received, decrypted, and decoded at 2120 & 2124 and/or 2128 & 2132) and renders it to the subscriber user (via the speaker) 2134. In some aspects, it may be optional to attenuate one TDMA channel's audio with respect to the other TDMA channel at 2136.

If at 2130, the determination was something other than voice or hangtime, the subscriber also proceeds to 2134 where the subscriber then sums (mixes) the decoded voice (received, decrypted, and decoded at 2120 & 2124) and renders to the subscriber user. The whole receive process looks at both time slots, and if voice is on time slot 1 and time slot 2, then the voice is summed together.

A check is made at 2138 as to whether the PTT is pressed, and if it is not pressed then the flowchart loops back to 2120 with the subscriber receiving in the first downlink TDMA channel. If the PTT is pressed at 2138, then a check is made as to whether TDMA channel 1 or TDMA channel 2 is in call hangtime at 2140. If no, then the subscriber denies the PTT request (because there is no available channel for the subscriber unit to begin a transmission) and plays a PTT denial or reject tone at 2142 and loops back to the subscriber receiving in the first downlink TDMA channel at 2120. If yes at 2140, (TDMA channel 1 or TDMA channel 2 is in call hangtime), then the subscriber selects an available TDMA channel for transmission at 2144 and returns to the transmit path at 2108. Another option at 2144 is to arbitrate the selected logical channel to ensure that only one subscriber unit attempts to initiate a transmission in the selected TDMA channel. Again, the flowchart loops back to 2108 for the subscriber to transmit in the selected uplink channel.

Returning to the beginning start of the call on the API side, the multi-talk group call request comes in automatically via the API, at 2150. This automation may optionally specify a call duration. When the call duration timer expires, the resource allocator causes the repeater to end the call by setting both the downlink TDMA channels to channel hangtime.

The flowchart proceeds to 2152 where the resource allocation grants the multi-talk group call. The resource allocator granting the multi-talk group call comprises allocating two logical channels on a first repeater for the call, assigning group members to a first logical channel on a first repeater, providing an audible alert to all group participants at the start of the call, and transmitting call hangtime by the repeater in every allocated downlink TDMA channel. The flow chart then proceeds down the receive path to receive in the first downlink TDMA channel at 2120.

To recap, the various aspects and examples provide for a TDMA communication system, comprising . a plurality of subscriber units, a base repeater associated with a trunked controller, the trunked controller receiving channel requests and transmitting channel grants to at least two of the subscriber units, and wherein the base repeater comprises a microprocessor configured to determine an asymmetric channel structure for voice communications between the plurality of subscriber units and the base repeater, and between the base repeater and the plurality of subscriber units.

The TDMA communication system may further comprise: a first vocoder and a second vocoder, wherein the first vocoder has a first fidelity level having a first bit rate, and the second vocoder has a second lower fidelity level having a second bit rate. The asymmetric channel structure may comprise a primary subscriber unit assigned to a primary channel for a talker having higher priority, and a secondary subscriber unit assigned to a secondary channel for a talker having lower priority. The asymmetric channel structure may support an asymmetric channel structure comprising a first channel containing a plurality of burst structures and a second channel containing fewer burst structures than the first channel structure. For example, the asymmetric channel structure may comprise a first channel containing two burst structures; and a second channel containing one burst structure, thereby providing a 2:1 channel structure for the voice communications.

In some aspects the asymmetric channel structure comprises an asymmetrical 8:4 TDMA channel structure with a total of twelve bursts spanning 360 msec, the asymmetrical 8:4 TDMA channel structure allocating eight bursts to one TDMA Logical Channel and four bursts to the other logical channel.

The base repeater manages a group call between the plurality of subscribers, wherein: a priority subscriber of the group, transmits a voice communication on an uplink of the first logical channel and the repeater receives the voice communication on a downlink of the first logical channel, the voice transmission being transmitted/repeated by the base repeater on a downlink of the first channel and received by a first talk group on a downlink of the first logical channel; and a secondary subscriber unit of a talkgroup transmits a secondary voice call on a an uplink of a second logical channel to the base repeater, the base repeater receives the secondary voice call on the uplink of the second logical channel, the base repeater then transmits (repeats) the second voice call, on a downlink of the second logical channel, and the remaining subscriber units of the talkgroup receive the secondary voice call on the downlink of the second logical channel.

In some aspects a priority subscriber, of the plurality of subscribers, receives: voice communication from a second subscriber played out at a speaker of the first subscriber, and the second subscriber unit can hear the first subscriber unit, and the remaining subscribers can hear the first and second subscriber units.

The system supports a multi-talk group call (a group call where there may be multiple users transmitting at the same time). The primary subscriber transmission may be communicated using high fidelity audio, while the secondary subscriber transmission is communicated using a nominal transmission having greater than AMBE+2) fidelity audio, wherein the TDMA channel supports two contemporaneous voice streams, thereby supporting multi-talk group voice call.

The communication system of FIGS. 1, 2, 3 and the subsequent operation and examples may also be summarized as comprising: a system resource allocator assigning one logical channel, of N logical channels of a repeater, the repeater comprising an uplink TDMA channel on which a subscriber transmits, in response to a PTT press, and a downlink TDMA channel on which the transmission is repeated by the repeater, the subscriber unit being part of a talkgroup, the system resource allocator assigns another one logical channel of the N logical channels of the repeater to all non-transmitting subscriber units belonging to the talkgroup to share, the one logical channel assigned to all non-transmitting subscriber units remains idle and in call hangtime until one of the non-transmitting subscriber units initiates a PTT transmission, using an uplink TDMA channel assigned to the non-transmitting subscriber units, and all subscriber units belonging to the talkgroup receive all active downlink TDMA channels not containing their own repeated transmission, de-vocode the audio streams, sum/mix the audio streams, and render the summed/mixed audio stream to audio speakers of respective subscriber units.

In some s embodiments, the plurality of subscriber units are each transmitting on respective uplink TDMA channels within the talkgroups and the summed/mixed audio stream of the plurality of subscriber units is rendered to audio speakers of each of the plurality of subscriber units.

In some embodiments, the system attenuates some audio streams with respect to other audio streams for ease of human understanding, prior to summing/mixing the audio stream. In some embodiments, the N assigned logical channels is greater than or equal to 2. The system supports an asymmetric channel structure. The assymetri channel structure allows for first and second vocoders of different fidelity, wherein the first vocoder has higher fidelity audio than the second vocoder. The repeater may also support a symmetric channel structure, wherein the subscriber unit comprises first and second vocoders of equal fidelity audio.

In the foregoing specification, various embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. For example, it should be understood that although certain drawings illustrate hardware and software located within particular devices, these depictions are for illustrative purposes only. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Additionally, methods described herein are not limited to being performed independently, and at least some blocks performed by each method may be combined with another method.

The benefits, advantages, solutions to problems, and any element(s) that may cause any benefit, advantage, or solution to occur or become more pronounced are not to be construed as a critical, required, or essential features or elements of any or all the claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

We claim:

1. A TDMA communication system, comprising:
a plurality of subscriber units;
a base repeater associated with a trunked controller, the trunked controller receiving channel requests and transmitting channel grants to at least two of the subscriber units; and
wherein the base repeater comprises a microprocessor configured to determine an asymmetric channel structure for voice communications between the plurality of subscriber units and the base repeater, and between the base repeater and the plurality of subscriber units.

2. The TDMA communication system of claim 1, further comprising: a first vocoder and a second vocoder, wherein the first vocoder has a first fidelity level having a first bit rate, and the second vocoder has a second lower fidelity level having a second bit rate.

3. The TDMA communication system of claim 1, wherein the asymmetric channel structure supports:
a primary subscriber unit assigned to a primary channel for a talker having higher priority; and
a secondary subscriber unit assigned to a secondary channel for a talker having lower priority.

4. The TDMA communication system of claim 1, wherein the asymmetric channel structure comprises a first channel containing a plurality of burst structures and a second channel containing fewer burst structures than the first channel structure.

5. The TDMA communication system of claim 1, wherein the plurality of subscriber units form a multi-talk group where there are multiple subscriber units transmitting at a time.

6. The TDMA communication system of claim 1, wherein the asymmetric channel structure comprises:
a first logical channel containing a first burst structure; and
a second logical channel containing a second burst structure, wherein the first burst structure and the second burst structure provide a 2:1 channel structure for the voice communications.

7. The TDMA communication system of claim 1, wherein the asymmetric channel structure comprises an asymmetrical 8:4 TDMA channel structure with a total of twelve bursts spanning 360 msec, the asymmetrical 8:4 TDMA channel structure allocating eight bursts to one TDMA Logical Channel and four bursts to the other logical channel.

8. The TDMA communication system of claim 1, wherein the base repeater manages a group call between the plurality of subscribers, wherein:
a priority subscriber of the group transmits a primary voice communication on the uplink of the first logical channel and the base repeater receives the primary voice communication on the uplink of the first logical channel, the primary voice communication being transmitted (repeated) by the base repeater on the downlink of the first logical channel and received by a talk group on the downlink of the first logical channel; and
a secondary subscriber unit of the group transmits a secondary voice communiction on the uplink of a second logical channel and the base repeater receives the secondary voice communication on the uplink of the second logical channel, the secondary voice communication being transmitted (repeater) by the base repeater on the downlink of the second logical channel, and received by the talkgroup on the downlink of the second logical channel.

9. The TDMA communication system of claim 1,
The TDMA communication system of claim 1, wherein a transmitting priority subscriber, of the plurality of subscribers, receives voice communication from a transmitting secondary subscriber played out at a speaker of the first subscriber;
a transmitting secondary subscriber, of the plurality of subscribers, receives voice communication from the transmitting priority subscriber played out at a speaker of the second subscriber.

10. The TDMA communication system of claim 6, the remaining subscribers, of the plurality of subscribers, receive voice communication from the transmitting priority and secondary subscribers played out at the speakers of the respective subscribers.

11. The TDMA communication system of claim 1, where the primary subscriber transmission is communicated using higher fidelity audio, while the secondary subscriber transmission is communicated using a lower fidelity audio relative to the higher fidelity audio, wherein the TDMA channel enables two contemporaneous voice streams, thereby supporting multi-talk group voice call.

12. The TDMA communication system of claim 1, the Trunk Controller allocates an entire repeater to a Multi-Talk Group Voice Call.

13. The TDMA communication system of claim 1, wherein the asymmetric channel structure allocates a higher data rate (bit per second (bps)) for primary voice in timeslot 1 and a lower data rate (bps) in timeslot 2 for secondary voice, thereby enabling, a higher fidelity vocoder for use with primary audio in timeslot 1 and a lower fidelity vocoder for use with secondary audio in timeslot 2.

14. A communication system, comprising:
a system resource allocator assigning one logical channel, of N logical channels of a repeater, the repeater comprising an uplink TDMA channel on which a subscriber transmits, in response to a PTT press, and a downlink TDMA channel on which the transmission is repeated by the repeater, the subscriber unit being part of a talkgroup;
the system resource allocator assigns another one logical channel of the N logical channels of the repeater to all non-transmitting subscriber units belonging to the talkgroup to share;
the one logical channel assigned to all non-transmitting subscriber units remains idle and in call hangtime until one of the non-transmitting subscriber units initiates a PTT transmission, using an uplink TDMA channel assigned to the non-transmitting subscriber units; and
all subscriber units belonging to the talkgroup receive all active downlink TDMA channels not containing their own repeated transmission, de-vocode the audio streams, sum/mix the audio streams, and render the summed/mixed audio stream to audio speakers of respective subscriber units.

15. The communication system of claim 14, wherein a plurality of subscriber units are each transmitting on respective uplink TDMA channels within the talkgroups and the summed/mixed audio stream of the plurality of subscriber units is rendered to audio speakers of each of the plurality of subscriber units.

16. The communication system of claim 14, further comprising:
attenuating some audio streams with respect to other audio streams for ease of human understanding, prior to summing/mixing the audio stream.

17. The communication system of claim 14, wherein N assigned logical channels is greater than or equal to 2.

18. The communication system of claim 14, wherein the repeater supports an asymmetric channel structure.

19. The communication system of claim 18, wherein the subscriber unit comprises first and second vocoders, the first vocoder having higher fidelity audio than the second vocoder.

20. The communication system of claim 14, wherein the repeater supports a symmetric channel structure.

21. The communication system of claim 19, wherein the subscriber unit comprises first and second vocoders of equal fidelity audio.
